(19) United States
(12) Patent Application Publication
(10) Pub. No.: US 2013/0015181 A1
(43) Pub. Date: Jan. 17, 2013

(54) Method and apparatus for pyrolysis of low loss material using microwave energy

(71) Applicants: Joseph E. Cosgrove, Columbia, CT (US); Marek A. Wójtowicz, East Hartford, CT (US); Michael A. Serio, Sturbridge, MA (US)

(72) Inventors: Joseph E. Cosgrove, Columbia, CT (US); Marek A. Wójtowicz, East Hartford, CT (US); Michael A. Serio, Sturbridge, MA (US)

(73) Assignee: Advanced Fuel Research , Inc.

(21) Appl. No.: 13/507,614

(22) Filed: Jul. 13, 2012

Related U.S. Application Data
(60) Provisional application No. 61/572,358, filed on Jul. 14, 2011.

(51) Int. Cl. H05B 6/64

(52) U.S. Cl. 219/759

(57) ABSTRACT

A method and apparatus that enable high efficiency microwave heating, for pyrolysis of low loss materials (i.e. poor absorbers of microwave energy). A unique microwave susceptor geometry is employed to enhance the heating of the low loss material. The geometry is such that the microwave radiation is caused to impinge upon the susceptor body, with the low loss material being effectively interposed between the microwave source and the susceptor body.

### CROSS REFERENCE TO RELATED APPLICATION

This application claims the benefit of U.S. Provisional Patent Application No. 61/572,358, filed Jul. 14, 2012, the entire specification of which is hereby incorporated hereinto by reference thereto.

### STATEMENT REGARDING GOVERNMENT INTEREST

The United States Government has rights in this invention under National Aeronautics and Space Administration contracts Nos. NNX09CC55P and NNX10CA22C.

### BACKGROUND OF THE INVENTION

Pyrolysis is a process of thermal decomposition of an organic material to produce gases, liquids (tar) and char (solid residue). Pyrolysis is usually understood to occur in an oxygen-free atmosphere. Gaseous, liquid and solid pyrolysis products can all be used as fuels, with or without prior upgrading, or they can be utilized as feedstocks for chemical or material industries. The types of materials which are candidates for pyrolysis processes include plant biomass, human and animal wastes, food scraps, crop residues, crop processing wastes, prunings, paper, cardboard, plastics and rubber. These products are often polymeric in nature and pyrolysis represents a method of processing all of these feed-stocks into useful products. In the case of plant biomass, human and animal wastes, food scraps, paper and cardboard, pyrolysis can be used to produce chemicals or fuels in gaseous and/or liquid form. In the case of plastics and rubber, pyrolysis can sometimes be used for “recycling” previously manufactured materials back to monomers. The energy needed to heat the materials to pyrolysis temperatures is typically obtained by combustion of suitable fuels or by electrical resistance heating, which may be disadvantageous in certain circumstances. In these methods, heat is transferred through material by conduction, from the outer surface to the interior, and the surface temperature is always hotter than the interior temperature.

Microwave heating, which falls under the category of dielectric heating, offers the advantage that heat is generated more uniformly inside the material (volumetric heating). It can also provide time and energy savings, as well as an on/off heating environment for more controlled processing. Although microwave heating is common in the food industry as well as other industrial processes, such as rubber vulcanization, the use of microwave energy for pyrolysis processing has not found widespread application. Many of the materials listed above, by themselves, are not amenable to microwave processing because they are poor absorbers of microwave radiation at the typical microwave frequencies of 900 MHz and 2450 MHz, commonly used for industrial processing. An important material property is c″, the dielectric loss factor. It indicates how well a material absorbs microwave energy and how much energy is dissipated as heat and is typically both frequency and temperature dependent. Materials with E″<0.01 are considered to be low loss materials and relatively transparent (high penetration depth) to microwave energy such that they are difficult to heat. Materials with 0.01<∈″<5 are generally considered to be good candidates for microwave heating. Their properties are such that they are susceptible to microwave energy with sufficient penetration depth to allow for uniform heating. High loss materials (∈″>5) will heat quickly, but generally have a small penetration depth. If the material thickness exceeds the penetration depth, non-uniform heating can occur. However, these materials make excellent susceptor materials and are employed to assist in microwave heating of low loss materials. Examples of high loss materials include silicon carbide (∈″=11 at 2450 MHz) and granular activated carbon (∈″=4-38 at 2450 MHz).

In the current state of the art, microwave pyrolysis of low loss materials requires mixing in particles that are susceptible to the microwave energy, such as some form of granular carbon. When the thus amended material is subjected to microwave radiation, the susceptor particles rapidly heat and, in turn, pyrolyze the material in close proximity. An inherent problem with this methodology is believed to reside in the likelihood that radiation shielding, by char formed in the outer regions of a reaction vessel, significantly inhibits or, indeed, precludes heating of the material at or near the center of the vessel. This could be particularly problematic where the volume of material treated is sufficiently large that the rate of heating becomes conduction-limited, in a manner similar to that which occurs when the source of thermal energy is electric.

### SUMMARY OF THE INVENTION

The object of the invention is to provide a novel method and apparatus for pyrolyzing biomaterials, by means of microwave heating, where the biomaterial exhibits a low dielectric loss factor. It is a further object of this invention to provide a process and apparatus which is more efficient than that of the prior art. It is further yet an object of this invention to provide such a process and apparatus that results in little or no contamination of the pyrolyzed sample by susceptor particles.

It has now been found that certain of the foregoing and related objects of the invention are attained by the provision of a method for pyrolysis, by microwave irradiation, of a material having a low dielectric loss factor (i.e., having a value not in excess of about 0.001). More particularly, in a first preferred embodiment a susceptor body having a high dielectric loss factor (i.e., having a value not less than about 5) is disposed centrally within the mass of material, and a source of microwave radiation irradiates the susceptor body from at least one position disposed radially with respect to the susceptor body. The susceptor body will desirably be substantially cylindrical, with the volume of interposed material being of substantially annular form; the microwave field may extend circumferentially and in a concentric relationship to the susceptor body, or the radiation may emanate radially, from one or more locations toward the susceptor body, with the mass of material surrounding the susceptor. The susceptor body will typically comprise carbon of any suitable form (e.g., graphite, activated carbon, pyrolysis char) or silicon carbide, and may have the form of a solid or sintered member (e.g., a rod), or particles within a microwave-transparent, substantially tubular container, such as may be fabricated from quartz or alumina.

Objects of the invention are attained in a second preferred embodiment of the method wherein the susceptor body comprises a multiplicity of substantially planar elements, with the volume of interposed material being in the form of a deposit or layer distributed, in direct surface contact, upon a plurality of such elements, and with each of the planar elements being irradiated sequentially from the source of microwave radiation. In some instances the multiplicity of planar elements will most desirably be effectively connected, to provide a conveyor, which is operated so as to expose the deposit or layer of interposed material, distributed on each of the planar elements, seriatim to radiation from the microwave source. Generally, the mass of material being treated in the method will be of substantially organic composition, and will usually include plant biomass, human and animal wastes, food scraps, crop residues, crop processing wastes, prunings, paper, cardboard and plastics.

Other objects of the invention are attained by the provision of apparatus for effecting pyrolysis, by microwave irradiation, the apparatus comprising: means defining an enclosure; a source of microwave radiation; transport means for transporting a mass of material along a path through the enclosure; and means for introducing microwave radiation from the source into the enclosure for irradiation of the transport means, moving along the path, and material supported thereon, wherein the transport means comprises a susceptor body comprised of a multiplicity of substantially planar elements for supporting, in direct surface contact, material for pyrolysis. Typically, the susceptor body will comprise carbon or silicon carbide, and the planar elements may desirably be effectively connected so as to provide a conveyor for movement along the path through the enclosure.

### BRIEF DESCRIPTION OF THE SEVERAL VIEWS OF THE DRAWINGS

FIG. 1 depicts four stages of microwave heating for pyrolysis of low-loss materials, as currently practiced using a distribution of susceptor particles.

FIG. 2 depicts three stages of microwave heating for pyrolysis of low-loss materials, as practiced in accordance with the present invention.

FIG. 3 is a time-trace plot of pyrolysis gas products measured during the microwave pyrolysis of wheat straw using the method of the present invention.

FIG. 4 is a schematical illustration of a continuous feed microwave system for pyrolysis of low-loss materials, embodying the present invention.

### DETAILED DESCRIPTION OF THE INVENTION

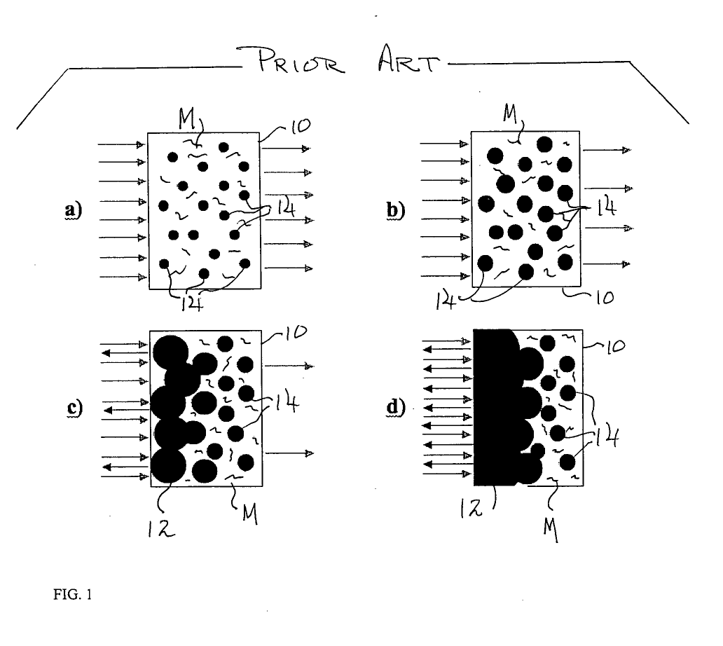

FIG. 1 illustrates the heating process that represents the current state of the art in microwave pyrolysis, using a distribution of susceptor granules. As shown in block a), the starting sample, contained in a microwave-transparent container 10, comprises raw biomass material M, throughout which is a dispersed particulate microwave susceptor material 14 such as activated carbon or char particles. Microwave energy, represented by inwardly directed arrows, irradiates the sample from the left (irradiation from one direction being depicted for simplicity; normally, however, radiation will impinge on the treated material from multiple directions). Initially, microwave energy is distributed uniformly throughout the material M, heating the individual susceptor particles. Most of the microwave energy is transmitted by the sample and emerges on the right side of block a), as indicated by the outwardly directed arrows; at this stage the sample is not an efficient absorber of the microwave energy.

As the process continues, localized heating of the mass M surrounding the individual susceptor particles occurs, pyrolyzing the material and converting it to char, effectively increasing the size of the susceptor particles as is indicated by the increased size depicted in block b). Incident microwave energy is, as a result, absorbed at an increased rate, which in turn leads to more efficient heating of the remaining material M.

As the reaction progresses further, the char formed along the left-hand region 12 of the sample becomes sufficiently large that it begins to shield the remaining material, thereby reducing penetration of the microwave energy into the sample bulk. At this stage, and as seen in block c), char formation dominates in the left region of the sample mass, where it begins to coalesce and re-radiate the absorbed microwave energy in the form of thermal (infrared) energy (as represented by the outwardly directed arrows on the left); eventually, a continuous outer char layer is formed on the left side, as shown in block d). Once such an outer char layer exceeds the penetration depth of the microwave energy, heating of the remaining sample region proceeds primarily by conduction (similar to conventional furnace heating) and without substantial absorption of microwave energy by the more remotely disposed particles, due to shielding by the char layer. Heating of the sample thus reaches a steady state condition; thermal radiation losses become substantial, convective losses into the cooler surrounding region are also significant, and the rate of pyrolysis becomes substantially slower.

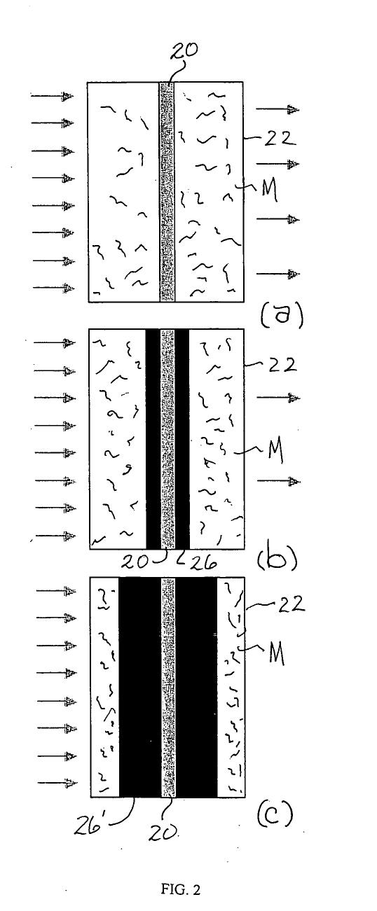

FIG. 2 is a schematic representation of an arrangement comprising the present invention, in which a susceptor body that strongly absorbs microwave radiation is disposed downstream of an energy field delivered from a microwave source and an interposed weak absorber material to be treated. More particularly, as seen in FIG. 2a, a rod 20 of lossy material, such as silicon carbide or graphite, is centrally positioned within the mass of material M contained in a microwave-transparent cylindrical reaction vessel 22. It will be appreciated by those skilled in the art that packed, confined beds of strong absorber particles could be used as susceptors instead of solid rods, and that (depending upon the configuration of the containment vessel and the shape and nature of the radiation field) various arrangements of a plurality of susceptor bodies can be employed; rod-like susceptors will typically be similar in length to the reaction vessel, and ¼ to ½ inch in diameter.

As in FIG. 1, incident microwave radiation represented by the inwardly directed arrows, is shown as emanating in only one direction. As a result of exposure to the microwave radiation, the absorber rod 20 will quickly heat, and begin to pyrolyze surrounding material M that lies in contact therewith, or in close proximity thereto.

Initially, heating efficiency is relatively poor since only a fraction of the incident microwave radiation is absorbed by the rod. As heated material M is converted to char however (deposits of which are designated 26 and 26′ in FIGS. 2b and 2c, respectively), the effective susceptor surface area core continues to grow until all of the sample has been pyrolyzed.

The thus described “inside-out” heating technique of the present invention affords important advantages: Firstly, the growing surface of the central rod/char susceptor is always the hottest area, and in contact with or in close proximity to the feedstock, or raw material. Secondly, radiative losses are reduced; i.e., the outer raw material transmits microwave radiation to the central core, but thermal radiation from the core itself is attenuated until the biomass is completely pyrolyzed. In addition, the outer volume of raw material acts as an insulation layer, thereby reducing convective losses. The thickness of the mass of material can also be maximized, to the extent that uniform radiation fields can be maintained throughout the microwave oven cavity. In contrast, using a centrally positioned electric heater, in a similar reactor geometry, the hottest region would always be present on the heater itself; the rate of pyrolysis would therefore decrease as additional char is formed, and the remaining mass of material would thereby be insulated from the thermal energy generated by the electric heater. Finally, the pyrolyzed sample can be removed uncontaminated by the susceptor, in contrast to the current state of the art employing distributed susceptor particles.

Demonstrative of the effectiveness of the present invention is the following example:

### Example

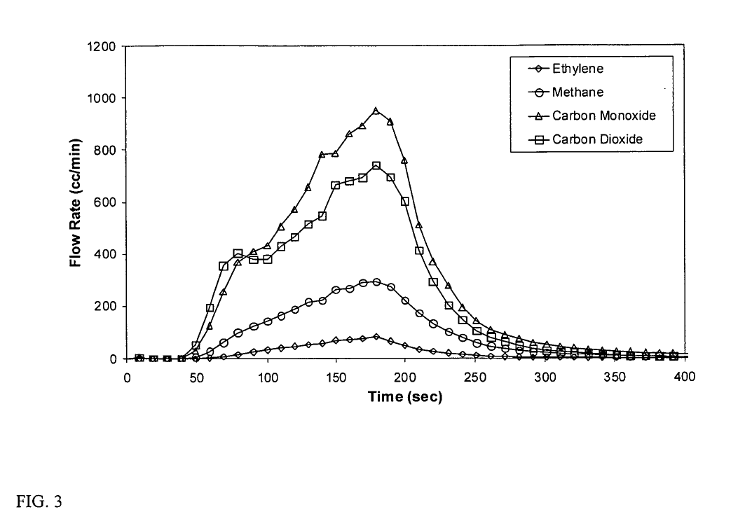

Microwave heating of dry wheat straw has been performed in a standard multimode oven cavity operating at 2450 MHz, using the method described in the present invention. A 20 g sample of wheat straw was placed in a quartz reaction vessel with a height of 50 mm and a diameter of 70 mm. A 50 mm tall by 8 mm diameter quartz tube filled with activated carbon granules (1.5 g) was used as the susceptor and inserted into the center of the sample mass, from top to bottom of the reaction vessel. FIG. 3 depicts a time-trace plot of the flow rates measured for four common pyrolysis gases after irradiation with an estimated 200 W of incident microwave power. After ˜50 seconds, the first gases are observed. The highest flows are observed about 3 minutes into the process and then sharply decline, tapering to negligible levels six minutes into the run. The remaining char fraction of 0.24, by weight, is typical for pyrolysis of the wheat straw material and is indicative of complete pyrolysis.

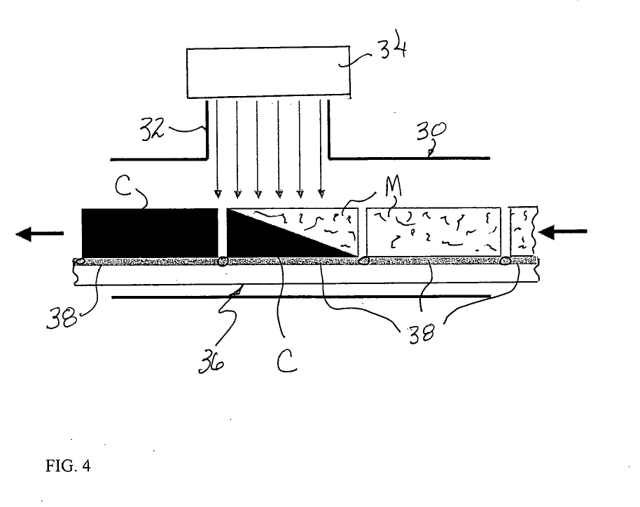

Turning now to FIG. 4 of the drawings, the system illustrated comprises a tunnel or enclosure, generally designated 30, having structure 32 defining a port for the entry of radiation (represented by inwardly directed arrows) produced by a microwave generator 34. A conveyor, generally designated by the numeral 36 (driven by means not shown), runs through the enclosure 30 in the direction indicated by the arrows at the opposite ends, and is comprised of a multiplicity of tiles 38 disposed end-to-end and fabricated from a material (e.g., silicon carbide or carbon) that is highly absorbent of microwave radiation, thus causing the tiles function as susceptor elements.

The low-loss material M to be treated is deposited on the tiles 38, in direct surface contact, adjacent the upstream (inlet) end of the conveyor 36. As the material M is transported through the enclosure 30 it is exposed to the microwave radiation delivered through the port structure 32, and becomes progressively pyrolyzed, to char C, by the heat of the tiles 38, with the reaction starting at the bottom of the deposit and causing the material M to become virtually completely converted to char C as the conveyor 36 exits the enclosure 30.

Thus, it can be seen that the present invention provides a novel method and apparatus for effecting pyrolysis using microwave-energy. More specifically, the invention provides a methodology for pyrolyzing low loss materials, using microwave radiation. The invention demonstrates that it is sufficient and advantageous to incorporate a single body susceptor, such as a rod, tile, or slab, into or with a low loss material for microwave pyrolysis, representing a significant advance in the art. Furthermore, the invention provides a method for pyrolyzing low loss materials, using microwave energy, that minimizes contamination of the pyrolyzed sample by susceptor particles, since the single-body susceptor can be easily removed from the post-pyrolysis sample.

Having thus described the invention, what is claimed is:

1. A method for pyrolysis, by microwave irradiation, of a material having a low dielectric loss factor, comprising:
providing a source of microwave radiation;
providing at least one susceptor body having a high dielectric loss factor, with a value not less than about 5, and positioning said susceptor body in spaced relationship to said microwave radiation source;
interposing between said source of microwave radiation and said susceptor body a mass of material having, in bulk, a low dielectric loss factor, with a value not in excess of about 0.01; and
operating said source of microwave radiation so as to irradiate said susceptor body through a volume of said interposed mass of material and thereby heat said susceptor body to a temperature sufficient to in turn heat a layer of said mass of interposed material lying in contact therewith to a temperature of at least about 200 degrees Centigrade, and maintaining such contact for a period of time sufficient to effect pyrolysis of the material comprising said layer.

2. The method of claim 1 wherein said susceptor body is disposed centrally within said mass of material, and wherein said source of microwave radiation irradiates said susceptor body from at least one position disposed radially with respect to said susceptor body.

3. The method of claim 2 wherein said susceptor body is substantially cylindrical, and wherein said volume of interposed material is of substantially annular form.

4. The method of claim 3 wherein said susceptor body comprises carbon or silicon carbide and is in the form of a solid member or particles within a substantially tubular and low loss container.

5. The method of claim 1 wherein said susceptor body comprises a multiplicity of substantially planar elements, wherein said volume of interposed material is in the form of a layer distributed, in direct surface contact, upon a plurality of said planar elements, and wherein each of said plurality of planar elements is irradiated sequentially from said source of microwave radiation.

6. The method of claim 5 wherein said multiplicity of planar elements are effectively connected to provide a conveyor, and wherein said conveyor is operated so as to expose said layer of interposed material, distributed on each of said planar elements, seriatim to radiation from said source of microwave radiation.

7. The method of claim 1 wherein said mass of material is of substantially organic composition.

8. The method of claim 7 wherein said mass of material is selected from the group consisting of biomass, polymers, and mixtures thereof.

9. Apparatus for effecting pyrolysis, by microwave irradiation, of a material having a low loss factor, comprising:
means defining an enclosure;
a source of microwave radiation;
transport means for transporting a mass of material along a path through said enclosure; and
means for introducing microwave radiation from said source into said enclosure, for irradiation of said transport means, moving along said path, and material supported thereon,
said transport means comprising a susceptor body comprised of a multiplicity of substantially planar elements for supporting, in direct surface contact, material for pyrolysis.

10. The apparatus of claim 9 wherein said planar elements are effectively connected to provide a conveyor for movement along said path through said enclosure.

11. The apparatus of claim 9 wherein said susceptor body comprises carbon or silicon carbide.
